(19) United States
(12) Patent Application Publication
(10) Pub. No.: US 2015/0308161 A1
(43) Pub. Date: Oct. 29, 2015

(54) MOTOR VEHICLE LOCK

(71) Applicant: BROSE SCHLIESSSYSTEME GMBH & CO. KG, WUPPERTAL (DE)

(72) Inventor: David Rosales, Rochester Hills, MI (US)

(21) Appl. No.: 14/554,613

(22) Filed: Nov. 26, 2014

Related U.S. Application Data
(60) Provisional application No. 61/985,842, filed on Apr. 29, 2014.

(51) Int. Cl. E05B 77/04; E05B 79/10; E05B 85/24

(52) U.S. Cl. CPC E05B 77/04; E05B 85/243; E05B 79/10

(57) ABSTRACT

The invention is directed to a motor vehicle lock, wherein a lock latch and a pawl, which is assigned to the lock latch, are provided, wherein a crash blocking arrangement is provided for blocking the deflection of the pawl from the engagement position into the release position, when the actuation movement of the pawl actuation lever surpasses a rapidity threshold and wherein a preliminary latch suppressing arrangement is provided for preventing the pawl from falling towards or into the engagement position at the preliminary latching detent during a closing cycle.

### CLAIM OF PRIORITY

This application claims the benefit of U.S. Provisional Application No. 61/985,842, filed Apr. 29, 2014, the content of which is hereby incorporated herein by reference in its entirety.

### FIELD OF THE INVENTION

The invention is directed to a motor vehicle lock for a motor vehicle door, as well as to a method for operating such a motor vehicle lock.

### BACKGROUND

The motor vehicle lock in question is assigned to a motor vehicle door. The expression “motor vehicle door” is to be understood in a broad sense. It includes in particular side doors, back doors, lift gates, trunk lids or engine hoods. Such a motor vehicle door may generally be designed as a sliding door as well.

The safety plays an important role for today's motor vehicle locks. It is of particular importance that crash induced acceleration does not lead to an unintended opening of the motor vehicle door. The focus of the present application is to prevent an unintended opening of the motor vehicle door based on crash induced acceleration. In case of a side impact on the motor vehicle the outer door handle may be reluctant to follow the impact due to mass inertia of the outer door handle. As a result a relative movement between the outer door handle and the motor vehicle door occurs, which again may lead to an unintended opening of the motor vehicle door. Due to the high crash accelerations this relative movement may take place with extreme rapidity.

The predominant role of any crash safety measure is to prevent the above noted unintended opening of the motor vehicle door. However, it is almost of equal importance not to reduce the user friendliness by the respective crash safety measure.

It is an object of the invention to provide a motor vehicle lock with improved crash safety without reducing the user friendliness.

### SUMMARY

According to an embodiment, a motor vehicle lock comprises a lock latch and a pawl, which is assigned to the lock latch. The lock latch can be brought into an open position, into a preliminary latching position and into a main latching position. The lock latch, when in one of the latching positions, is or may be brought into holding engagement with a lock striker. During a closing cycle of the motor vehicle lock the lock latch moves from the open position via the preliminary latching position to the main latching position, driven by the lock striker. Normally, the motor vehicle lock is arranged at the assigned motor vehicle door, while the lock striker is arranged at the vehicle body. This may be the other way around as well.

The main function of providing a preliminary latching position is to guarantee that in case the pawl fails to hold the lock latch in the main latching position during driving operation of the motor vehicle, the lock latch may still slip into engagement with the pawl in the preliminary latching position, such that the motor vehicle door does not open unintentionally.

The pawl may fall into at least one engagement position, in which it is in blocking engagement with a preliminary latching detent or a main latching detent of the lock latch for locking the lock latch in its preliminary latching position or its main latching position. For opening the motor vehicle door, the pawl may be deflected into at least one release position, in which it releases the lock latch, such that the lock latch may release the lock striker. For deflecting the pawl into the release position, a pawl actuation lever is provided.

In order to prevent the pawl from being deflected due to crash accelerations, according to the invention, a crash blocking arrangement is provided. The blocking arrangement blocks the deflection of the pawl from the engagement position into the release position, when the actuation movement of the pawl actuation lever surpasses a rapidity threshold. Such a crash blocking arrangement may be realized in a reliable manner with low constructional effort.

However, a challenge is still the possibility of the pawl falling into the engagement position at the preliminary detent during a closing cycle. With the motor vehicle lock as just described the pawl may fall into the engagement position at the preliminary detent, if the user closes the motor vehicle door with very low impact force. Depending on the construction of the blocking arrangement, jamming between the pawl and the blocking arrangement may occur, especially if the user then repeatedly forces the motor vehicle door into the closing direction.

In order to overcome the above noted issue the proposed motor vehicle lock is provided with a preliminary latch suppressing arrangement. The preliminary latch suppressing arrangement is provided for preventing the pawl from falling towards or into the engagement position at the preliminary detent during a closing cycle. The above noted risk of jamming is accordingly eliminated.

As a result, it is the combination of the crash blocking arrangement with the preliminary latch suppressing arrangement that leads to an increased crash safety without negatively affecting the user friendliness of the motor vehicle lock.

In an embodiment, the blocking arrangement comprises a blocking lever, which serves not only for blocking of the pawl or the pawl actuation lever, but also for guaranteeing the blocking arrangement to move into or remain in the blocking state when the actuation movement of the pawl actuation lever surpasses a rapidity threshold.

Embodiments disclosed herein relate to the realization of the preliminary latch suppressing arrangement. In an embodiment, the preliminary suppressing arrangement enters into the suppressing state, if the pawl is being deflected from the engagement position into the release position. In an embodiment, the pawl may be released from the preliminary latch suppressing element once the lock latch is performing a closing cycle, in particular once the lock latch has been moved beyond the preliminary latching position.

A second teaching is directed to a method for operating a motor vehicle lock. All variants, alternatives and advantages, that may be taken from the description of other embodiments herein (for example, embodiments of the motor vehicle lock for a motor vehicle door), are also accordingly applicable to the method for operating a motor vehicle lock.

The motor vehicle lock, which serves as a basis for the claimed method, comprises a lock latch and a pawl, which is assigned to the lock latch. The lock latch can be brought into an open position, into a preliminary latching position and into a main latching position as noted above. Accordingly, the lock latch, which is in one of the latching positions, is or may be brought into holding engagement with a lock striker. A closing cycle of the motor vehicle door lock comprises moving the lock latch from the open position via the preliminary latching position to the main latching position, wherein the pawl may fall into at least one engagement position, in which it is in blocking engagement with a preliminary latching detent or a main latching detent of the lock latch for blocking the lock latch in its preliminary latching position or its main latching position. The pawl may be deflected into at least one release position, in which it releases the lock latch. For deflecting the pawl into the release position, a pawl actuation lever is provided. The release of the pawl from the engagement position into the release position is being blocked by a crash blocking arrangement, when the actuation movement of the pawl actuation lever surpasses a rapidity threshold. According to the above, the pawl is being prevented from falling towards or into the engagement position at the preliminary detent during a closing cycle by a preliminary latch suppressing arrangement.

In an embodiment, the invention includes a motor vehicle lock, wherein a lock latch and a pawl, which is assigned to the lock latch, are provided, wherein the lock latch can be brought into an open position, into a preliminary latching position and into a main latching position, wherein the lock latch, when in one of the latching positions, is or may be brought into holding engagement with a lock striker, wherein a closing cycle of the motor vehicle lock comprises moving the lock latch from the open position via the preliminary latching position to the main latching position, wherein the pawl may fall into at least one engagement position, in which it is in blocking engagement with a preliminary latching detent or a main latching detent of the lock latch for blocking the lock latch in its preliminary latching position or its main latching position, wherein the pawl may be deflected into at least one release position, in which it releases the lock latch, wherein a pawl actuation lever is provided for deflecting the pawl into the release position, wherein a crash blocking arrangement is provided for blocking the deflection of the pawl from the engagement position into the release position, when the actuation movement of the pawl actuation lever surpasses a rapidity threshold, wherein a preliminary latch suppressing arrangement is provided for preventing the pawl from falling towards or into the engagement position at the preliminary latching detent during a closing cycle.

In an embodiment, the pawl is pretensioned into the engagement position by a pawl spring arrangement.

In an embodiment, the preliminary latching detent and the main latching detent are arranged at the circumference of the lock latch and their radial locations with reference to a geometrical latch axis of the lock latch are basically similar.

In an embodiment, the crash blocking arrangement is moveable between a blocking state, in which it blocks the release of the pawl, and a release state, in which it releases the pawl, and an inertial characteristic of the blocking arrangement causes the blocking arrangement to move into or remain in the blocking state when the actuation movement of the pawl actuation lever surpasses a rapidity threshold.

In an embodiment, normal actuation of the pawl actuation lever causes the blocking arrangement to move into or remain in the release state, before said actuation causes deflection of the pawl into its release position.

In an embodiment, the blocking arrangement is pretensioned into the blocking state by a blocking spring arrangement and falls into the blocking state when the pawl falls into the engagement position.

In an embodiment, the blocking arrangement comprises an inertia element, which inertial characteristic causes the blocking arrangement to move into or remain in the blocking state when the actuation movement of the pawl actuation lever surpasses a rapidity threshold.

In an embodiment, the blocking arrangement comprises a blocking lever, which in the blocking state of the blocking arrangement is in blocking engagement with the pawl or the pawl actuation lever.

In an embodiment, the preliminary latch suppressing arrangement may be brought into a suppressing state, in which it is in engagement with the pawl preventing the pawl from falling into the engagement position, and a release state, in which it releases the pawl.

In an embodiment, deflection of the pawl from the engagement position into the release position causes the preliminary latch suppressing arrangement to enter into the suppressing state.

In an embodiment, the lock latch moving beyond the preliminary latching position during a closing cycle causes the preliminary latch suppressing arrangement to enter into the release state.

In an embodiment, the lock latch moving into the main latching position during a closing cycle causes the preliminary latch suppressing arrangement to enter into the release state.

In an embodiment, the preliminary latch suppressing arrangement comprises a preliminary latch suppressing element, which, when in a suppressing position, is in engagement with the pawl preventing the pawl from falling into the engagement position and which, when in a release position, releases the pawl.

In an embodiment, the preliminary latch suppressing element is pretensioned into the suppressing position by a suppression spring arrangement.

In an embodiment, the preliminary latch suppressing element comprises a detent, which snaps into engagement with the pawl, thereby having the preliminary suppression arrangement to enter into the suppressing state, during deflection of the pawl from the engagement position into the release position.

In an embodiment, the lock latch comprises an ejector element which moves the preliminary latch suppressing element into the release position during a closing cycle.

In an embodiment, the preliminary latch suppressing element is a lever pivotable around an axis. In another embodiment, the preliminary latch suppressing element is an elastically bendable wire or strip.

An embodiment includes a method for operating a motor vehicle lock, wherein the motor vehicle lock comprises a lock latch and a pawl, which is assigned to the lock latch, wherein the lock latch can be brought into an open position, into a preliminary latching position and into a main latching position, wherein the lock latch, when in one of the latching positions, is or may be brought into holding engagement with a lock striker, wherein a closing cycle of the motor vehicle lock comprises moving the lock latch from the open position via the preliminary latching position to the main latching position, wherein the pawl may fall into at least one engagement position, in which it is in blocking engagement with a preliminary latching detent or a main latching detent of the lock latch for blocking the lock latch in its preliminary latching position or its main latching position, wherein the pawl may be deflected into at least one release position, in which it releases the lock latch, wherein a pawl actuation lever is provided for deflecting the pawl into the release position, wherein the deflection of the pawl from the engagement position into the release position is being blocked by a crash blocking arrangement, when the actuation movement of the pawl actuation lever surpasses a rapidity threshold, wherein the pawl is being prevented from falling towards or into the engagement position at the preliminary latching detent during a closing cycle by a preliminary latch suppressing arrangement.

In an embodiment, the engagement position of the pawl when in engagement with the preliminary latching detent is basically similar to the engagement position of the pawl when in engagement with the main latching detent.

In an embodiment, the blocking lever comprises an inertia element, which inertial characteristic causes the blocking arrangement to move into or remain in the blocking state when the actuation movement of the pawl actuation lever surpasses a rapidity threshold.

### BRIEF DESCRIPTION OF THE FIGURES

Some embodiments will hereinafter be described in conjunction with the appended drawings, in which

FIG. 1 illustrates selected parts of a proposed motor vehicle lock in a rough sketch with the lock latch in the open position,

FIG. 2 illustrates the motor vehicle lock as shown in FIG. 1 with the lock latch in the main blocking position,

FIG. 3 illustrates the motor vehicle lock shown in FIG. 1 with the lock latch in the preliminary latching position, and

FIG. 4 illustrates the motor vehicle lock as shown in FIG. 1 with an embodiment for the preliminary latch suppressing arrangement.

### DETAILED DESCRIPTION

The motor vehicle lock 1 shown in the drawings is assigned to a motor vehicle door (not shown). Regarding the broad interpretation of the expression “motor vehicle door” reference is made to the introductory part of the specification. Here the motor vehicle door is a side door of the motor vehicle.

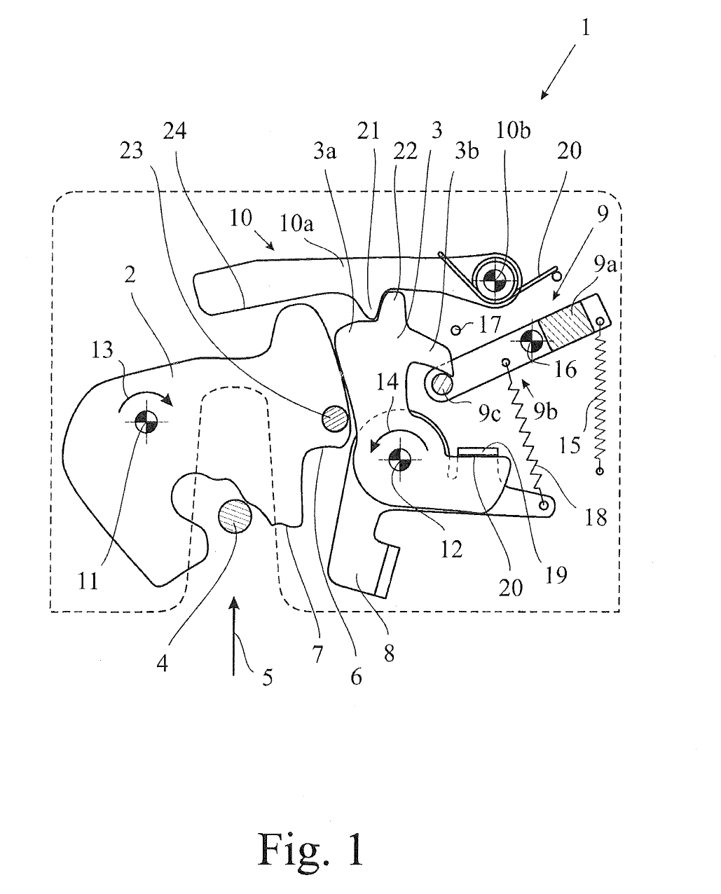

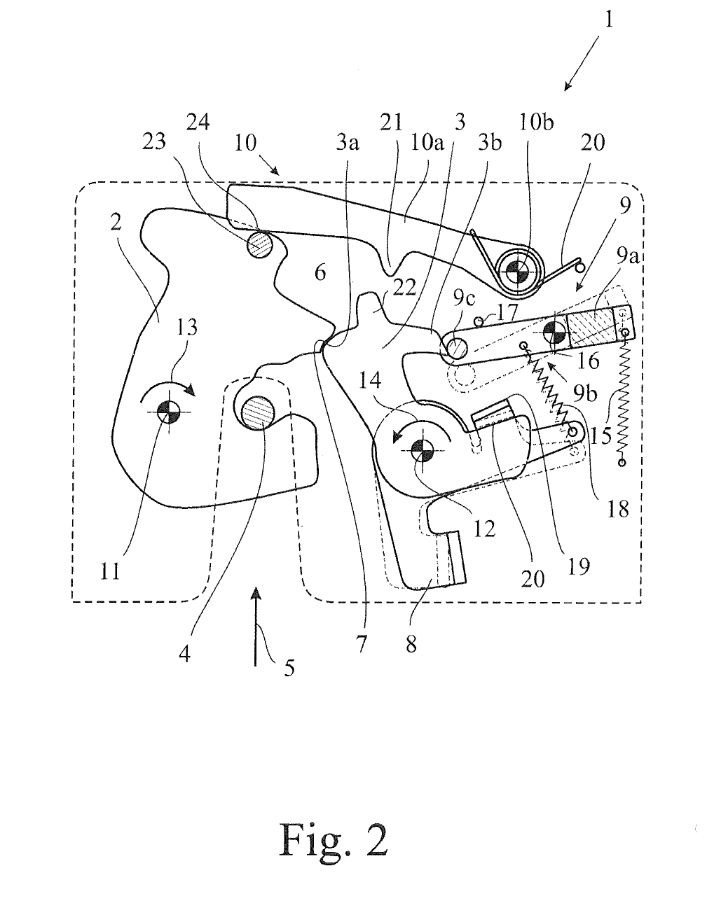

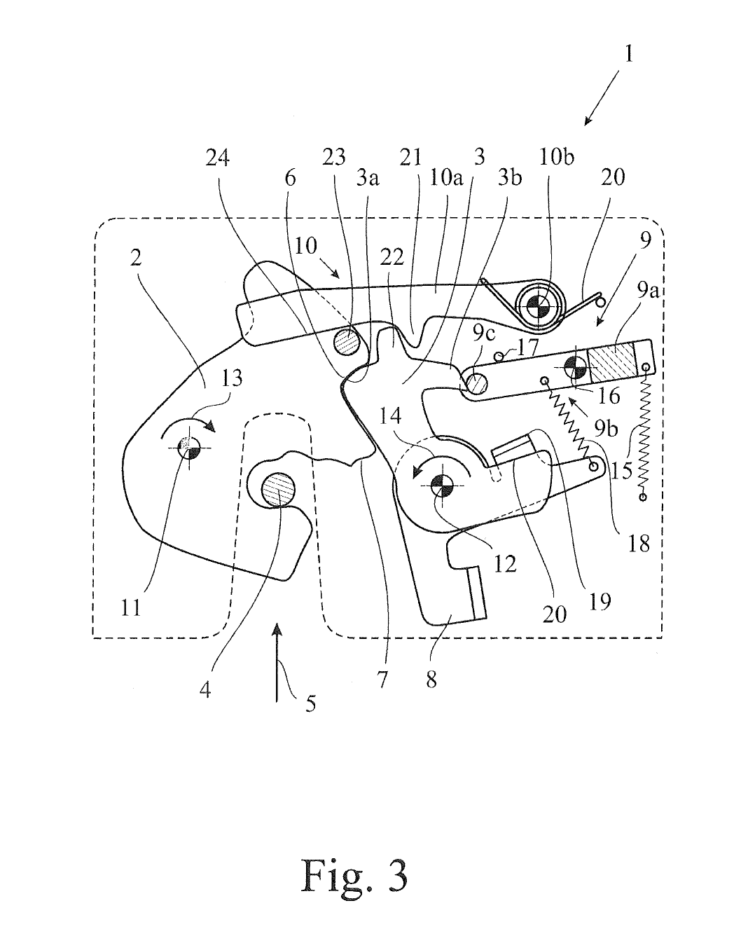

The motor vehicle lock 1 comprises the usual locking elements lock latch and pawl 3, which is assigned to the lock latch 2. The lock latch 2 can be brought into an open position (FIG. 1), into a preliminary latching position (FIG. 3) and into a main latching position (FIG. 2). The lock latch 2, when in one of the latching positions (FIG. 2, FIG. 3), is or may be brought into holding engagement with a lock striker 4.

A closing cycle of the motor vehicle lock 1 is initiated by the lock striker 4 coming into engagement with the lock latch 2 when the motor vehicle door is being closed by the user. The direction of travel of the lock striker 4 is denominated by reference number 5 in the drawings.

The above noted closing cycling of the motor vehicle lock 1 comprises moving the lock latch 2 from the open position (FIG. 1) via the preliminary latching position (FIG. 3) to the main latching position (FIG. 2), wherein the pawl 3 may fall into at least one engagement position, in which it is in blocking engagement with a preliminary latching detent 6 or a main latching detent 7. The engagement between the pawl 3 and the preliminary latching detent 6 or the main latching detent 7 leads to blocking the lock latch 2 in its preliminary latching position or its main latching position.

For opening the motor vehicle door the pawl 3 may be deflected into at least one release position (FIG. 1), in which it releases the lock latch 2. For performing such deflection movement, a pawl actuation lever 8 is provided.

In order to increase the crash safety, a crash blocking arrangement 9 is provided for blocking the deflection of the pawl 3 from the engagement position (FIG. 2) into the release position (FIG. 1), when the actuation movement of the pawl actuation lever 8 surpasses a rapidity threshold. In other words, when the pawl actuation lever 8 is being moved with extreme speed due to crash accelerations, the crash blocking arrangement 9 blocks the deflection of the pawl 3 from the engagement position into the release position. During an actuation movement of the pawl actuation lever 8 with normal speed, the blocking arrangement 9 releases the pawl 3 as will be explained later.

FIG. 3 shows a situation, in which the pawl 3 is in engagement with the preliminary latching detent 6. This may be the result of a closing cycle starting from the open position of the lock latch 2 (FIG. 1) and moving the lock latch 2 into the direction of the position shown in FIG. 2, but not fully reaching this position, such that the pawl 3 with its blocking section 3a is only in engagement with a tip of the main latching detent 7. During drive operation of the motor vehicle, in particular due to the resulting forces on the motor vehicle door, the pawl 3 may come out of engagement from the tip of the main latching detent 7 and slip into the preliminary latching position shown in FIG. 3. With a movement of the pawl actuation lever 8 the pawl 3 may then be released into its release position as will be explained later.

However, it becomes clear from FIG. 3 that the pawl 3 falling into engagement with a preliminary latching detent 6 during a closing cycle would be problematic, as further rotation of the lock latch 2 in the direction of its open position, starting from the position shown in FIG. 3, would lead to jamming of the pawl 3 with the blocking arrangement 9.

Therefore, according to the invention, a preliminary latch suppressing arrangement 10 is provided for preventing the pawl 3 from falling towards or into the engagement position at the preliminary latching detent 6 during a closing cycle. With the proposed preliminary latch suppressing arrangement 10 the lock latch 2, during a closing cycle, simply passes the preliminary latching position without the pawl 3 being able to fall into engagement with the preliminary latching detent 6.

Here the lock latch 2 is pivotable around a lock latch axis 11, while the pawl 3 is pivotable around a pawl axis 12. The lock latch 2 is pretensioned into the open position, in FIG. 1 clockwise, by a lock latch spring arrangement 13, while the pawl 3 is pretensioned into the engagement position, in FIG. 1 counter-clockwise by a pawl spring arrangement 14.

The drawings show that the preliminary latching detent 6 and the main latching detent 7 are arranged at the circumference of the lock latch 2 and that their radial locations with reference to a geometrical latch axis 11 of the lock latch 2 are basically similar. This presently means that the distance between the preliminary latching detent 6 and the geometrical latch axis 11 and the distance between the main latching detent 7 and the geometrical latch axis 11 are basically similar. In an embodiment, the engagement position of the pawl 3 when in engagement with the preliminary latching detent 6 (FIG. 3) is basically similar to the engagement position of the pawl 3 when in engagement with the main latching detent 7 (FIG. 2).

The crash blocking arrangement 9 is movable between the blocking state (FIG. 2, 3), in which it blocks the release of the pawl 3. The crash blocking arrangement 9 is also movable into a release state, in which it releases the pawl 3. It is of particular importance here that an inertial characteristic of the blocking arrangement 9 causes a blocking arrangement 9 to move into or, as shown in the drawings, to remain in the blocking state when the actuation movement of the pawl actuation lever 8 surpasses a rapidity threshold. Surpassing the rapidity threshold is expected to take place in a crash situation due to the resulting crash accelerations.

On the other hand, normal actuation of the pawl actuation lever 8 causes the blocking arrangement 9 to move into or remain in the release state, before said actuation of the pawl actuation lever 8 causes deflection of the pawl 3 into its release position.

In the shown embodiment the blocking arrangement 9 is pretensioned into the blocking state by a blocking spring arrangement 15 and falls into the blocking state when the pawl 3 falls into the engagement position. In an embodiment, the locking arrangement 9 always falls into the blocking state, when the pawl 3 falls into the engagement position. This means, that the pawl 3 engaging either the preliminary latching detent 6 or the main latching detent 7 is protected by the blocking arrangement 9 against deflection of the pawl 3 due to crash accelerations.

Here the blocking arrangement 9 comprises an inertia element 9a, which inertial characteristic causes the blocking arrangement 9 to move into or remain in the blocking state when the actuation movement of the pawl actuation lever 8 surpasses a rapidity threshold. Accordingly, the mass of the inertia element 9a is chosen such that the respective inertial characteristic is guaranteed.

In an embodiment, the blocking arrangement 9 comprises a blocking lever 9b, which in the blocking state of the blocking arrangement 9 is in blocking engagement with the pawl 3 or the pawl actuation lever 8. Here the blocking lever 9b during the blocking state is in blocking engagement with the pawl 3. In detail, the blocking element 9 comprises a pin 9c which may come into blocking engagement with a nose 3b at the pawl 3. The blocking lever 9b is pivotable around a blocking lever axis 16. For limiting the range of movement of the blocking lever 9b and also to provide a support of the blocking lever 9b against the blocking forces necessary to block the pawl 3, an end stop 17 is assigned to the blocking lever 9b.

For a normal deflection of the pawl 3, the pawl actuation lever 8 may be moved in FIG. 2 in clockwise direction. This movement of the pawl actuation lever 8 may go back on a manual movement of an outer door handle or an inner door handle of the motor vehicle door. As the pawl actuation lever 8 is coupled to the blocking lever 9b via a actuation spring arrangement 18, the blocking lever 9b follows the movement of the pawl actuation lever 8, such that the pin 9c leaves the path of movement of the nose 3b of the pawl 3, which as a result releases the pawl 3 from the blocking lever 9b. Then, after further movement of the pawl actuation lever 8 in clockwise direction, an abutment 19 at the pawl actuation lever 8 comes into engagement with a counter abutment 20 at the pawl 3. This state is shown in dotted lines in FIG. 2. Further movement of the pawl actuation lever 8 then leads to deflecting the pawl 3 into its release position and thereby releasing the lock latch 2 into its open position (FIG. 1).

If the actuation movement of the pawl actuation lever 8, due to high crash accelerations, surpasses a rapidity threshold, the inertia of the blocking lever 9b, in particular of the inertia element 9a, causes the blocking lever 9b to remain in the position shown in FIG. 2, blocking the pawl 3. The movement of the pawl actuation lever 8 solely causes lengthening of the actuation spring arrangement 18.

It becomes clear from the above, that a proper coordination of the actuation spring arrangement 18, the blocking spring arrangement 15 and the inertial characteristics of the blocking lever 9b is of considerable importance here.

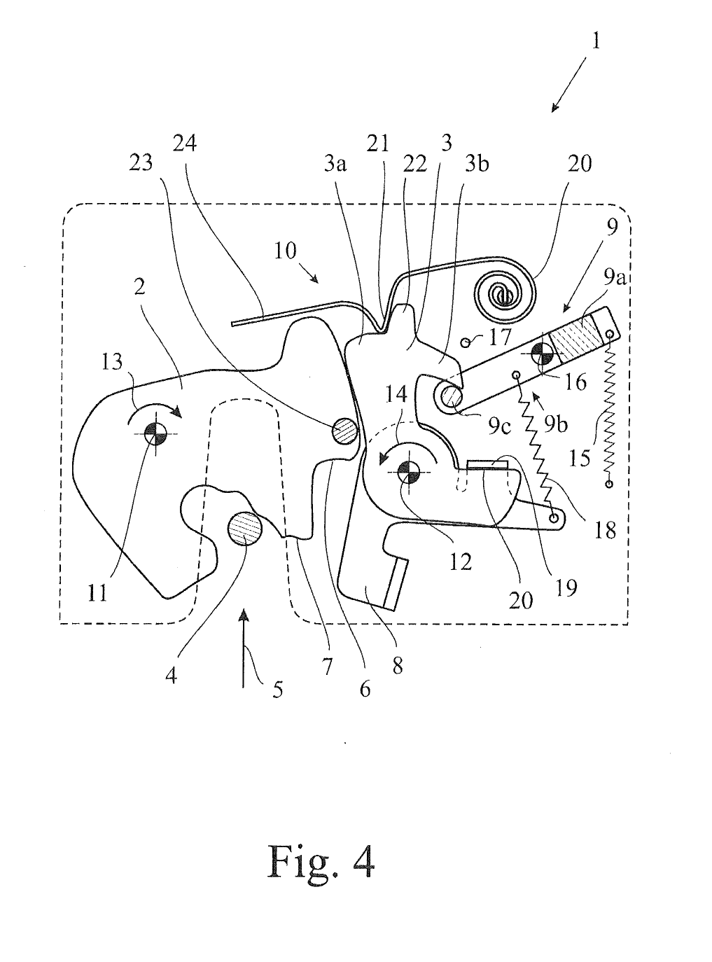

There are various ways possible to realize the preliminary latch suppressing arrangement 10 according to the invention. In an embodiment, the preliminary latch suppressing arrangement 10 may be brought into a suppressing state, in which it is in engagement with the pawl 3 preventing the pawl 3 from falling into the engagement position. This is shown in FIGS. 1 and 4. The preliminary latch suppressing arrangement 10 may also be brought into a release state, in which the preliminary latch suppressing arrangement 10 releases the pawl 3, as is shown in FIG. 2.

In an embodiment, the deflection of the pawl 3 from the engagement position to the release position, which may be caused by a movement of the pawl actuation lever 8 as noted above, causes the preliminary latch suppressing arrangement 10 to enter into the suppression state. This means that an actuation movement of the pawl actuation lever 8, during normal operation, leads to the pawl 3 being blocked in its release position by the preliminary latch suppressing arrangement 10.

As a result, during a closing cycle of the lock latch 2 the pawl 3 may not fall into engagement with the preliminary latching detent 6. The further course of movement of the lock latch 2, such as the lock latch 2 moving beyond the preliminary latching position, causes the preliminary latch suppressing arrangement 10 to enter into the release state, as FIGS. 1 and 2 shown in sequence. In particular, the lock latch 2 moving into the main latching position during a closing cycling causes the preliminary latch suppressing arrangement 10 to enter into the release state, such that the pawl 3 may fall into engagement with the main latching detent 7, driven by the pawl spring arrangement 14.

The mechanical structure of the shown preliminary latch suppressing arrangement 10 is simple and robust. The preliminary latch suppressing arrangement 10 comprises a preliminary latch suppressing element 10a, which here is designed as a preliminary latch suppressing lever pivotable around a pivot axis 10b. The latch suppressing element 10a, when in a suppressing position (FIG. 1, 4), which suppressing position corresponds to the suppressing state of the latch suppressing arrangement 10, is in engagement with the pawl 3 preventing the pawl 3 from falling into the engagement position. The preliminary latch suppressing element 10a, when in a release position, which release position corresponds to the release state of the latch suppressing arrangement 10, releases the pawl 3 (FIG. 2).

The preliminary latch suppressing element 10a shown in the drawings is pretensioned into the suppressing position by a suppression spring arrangement 20, which in FIGS. 1 to 3 acts on the preliminary latch suppressing element 10a in a counter clockwise direction.

Starting from the situation shown in FIG. 2, during deflection of the pawl 3 from the engagement position into the release position, in particular by an actuation movement of the pawl actuation lever 8, the pawl 3 releases the lock latch 2, such that the lock latch 2 moves into its opening position, thereby releasing the preliminary latch suppressing element 10a, as will be explained later. The release of the preliminary latch suppressing element 10a allows the preliminary latch suppressing element 10a to pivot in a counter clockwise direction. Here the preliminary latch suppressing element 10a comprises a detent 21, which snaps into engagement with a counter detent 22 of the pawl 3, thereby having the preliminary suppression arrangement 10 enter into the suppressing state (FIG. 1).

In order to provide the above noted interaction between the lock latch 2 and the preliminary latch suppressing element 10a, the lock latch 2 comprises an ejector element 23 which moves the preliminary latch suppressing element 10a into the release position during a closing cycle. Here the ejector element 23 is realized as a pin on the lock latch 2 which may come into engagement with a contour 24 at the preliminary latch suppressing element 10a.

As noted above, here the preliminary latch suppressing element 10a is a lever pivotable around a pivot axis 10b. An alternative to this is shown in FIG. 4. Here, the preliminary latch suppressing element 10a is an elastically bendable wire or strip. The movability of the preliminary latch suppressing element 10a according to FIG. 4 is provided by the elasticity of the wire or strip.

According to another teaching, a method for operating a motor vehicle lock 1 is disclosed. The motor vehicle lock 1, comprises a lock latch 2 and a pawl 3, which is assigned to the lock latch 2. The lock latch 3 can be brought into an open position, into a preliminary latching position and into a main latch position as explained above. The lock latch 3, which is in one of the latching positions, is or may be brought into holding engagement with a lock striker 4. A closing cycle of the motor vehicle lock 1 comprises moving the lock latch 3 from the open position via the preliminary latching position to the main latching position. The pawl 3 may fall into at least one engagement position, in which it is in blocking engagement with a preliminary latching detent 6 or a main latching detent 7 of the lock latch 3 for blocking the lock latch 3 in its preliminary latching position or its main latching position. The pawl 3 may be deflected into at least one release position, in which it releases the lock latch 3. A pawl actuation lever 8 is provided for deflecting the pawl 3 into the release position. In case the actuation movement of the pawl actuation lever surpasses a rapidity threshold, the deflection of the pawl 3 from the engagement position into the release position is being blocked by a crash blocking arrangement 9. As also explained above, the pawl 3 is being prevented from falling towards or into the engagement position at the preliminary detent during a closing cycle by a preliminary latch suppressing arrangement 10. Reference may be made to all explanations given in view of the operation of the proposed motor vehicle lock 1.

What is claimed is:

1. A motor vehicle lock, wherein a lock latch and a pawl, which is assigned to the lock latch, are provided, wherein the lock latch can be brought into an open position, into a preliminary latching position and into a main latching position, wherein the lock latch, when in one of the latching positions, is or may be brought into holding engagement with a lock striker, wherein a closing cycle of the motor vehicle lock comprises moving the lock latch from the open position via the preliminary latching position to the main latching position, wherein the pawl may fall into at least one engagement position, in which it is in blocking engagement with a preliminary latching detent or a main latching detent of the lock latch for blocking the lock latch in its preliminary latching position or its main latching position, wherein the pawl may be deflected into at least one release position, in which it releases the lock latch, wherein a pawl actuation lever is provided for deflecting the pawl into the release position, wherein a crash blocking arrangement is provided for blocking the deflection of the pawl from the engagement position into the release position, when the actuation movement of the pawl actuation lever surpasses a rapidity threshold, wherein a preliminary latch suppressing arrangement is provided for preventing the pawl from falling towards or into the engagement position at the preliminary latching detent during a closing cycle.

2. The motor vehicle lock according to claim 1, wherein the pawl is pretensioned into the engagement position by a pawl spring arrangement.

3. The motor vehicle lock according to claim 1, wherein the preliminary latching detent and the main latching detent are arranged at the circumference of the lock latch and wherein their radial locations with reference to a geometrical latch axis of the lock latch are basically similar.

4. The motor vehicle lock according to claim 1, wherein the crash blocking arrangement is moveable between a blocking state, in which it blocks the release of the pawl, and a release state, in which it releases the pawl, and that an inertial characteristic of the blocking arrangement causes the blocking arrangement to move into or remain in the blocking state when the actuation movement of the pawl actuation lever surpasses a rapidity threshold.

5. The motor vehicle lock according to claim 4, wherein normal actuation of the pawl actuation lever causes the blocking arrangement to move into or remain in the release state, before said actuation causes deflection of the pawl into its release position.

6. The motor vehicle lock according to claim 4, wherein the blocking arrangement is pretensioned into the blocking state by a blocking spring arrangement and falls into the blocking state when the pawl falls into the engagement position.

7. The motor vehicle lock according to claim 4, wherein the blocking arrangement comprises an inertia element, which inertial characteristic causes the blocking arrangement to move into or remain in the blocking state when the actuation movement of the pawl actuation lever surpasses a rapidity threshold.

8. The motor vehicle lock according to claim 4, wherein the blocking arrangement comprises a blocking lever, which in the blocking state of the blocking arrangement is in blocking engagement with the pawl or the pawl actuation lever.

9. The motor vehicle lock according to claim 1, wherein the preliminary latch suppressing arrangement may be brought into a suppressing state, in which it is in engagement with the pawl preventing the pawl from falling into the engagement position, and a release state, in which it releases the pawl.

10. The motor vehicle lock according to claim 9, wherein deflection of the pawl from the engagement position into the release position causes the preliminary latch suppressing arrangement to enter into the suppressing state.

11. The motor vehicle lock according to claim 9, wherein the lock latch moving beyond the preliminary latching position during a closing cycle causes the preliminary latch suppressing arrangement to enter into the release state.

12. The motor vehicle lock according to claim 9, wherein the lock latch moving into the main latching position during a closing cycle causes the preliminary latch suppressing arrangement to enter into the release state.

13. The motor vehicle lock according to claim 9, wherein the preliminary latch suppressing arrangement comprises a preliminary latch suppressing element, which, when in a suppressing position, is in engagement with the pawl preventing the pawl from falling into the engagement position and which, when in a release position, releases the pawl.

14. The motor vehicle lock according to claim 13, wherein the preliminary latch suppressing element is pretensioned into the suppressing position by a suppression spring arrangement.

15. The motor vehicle lock according to claim 13, wherein the preliminary latch suppressing element comprises a detent, which snaps into engagement with the pawl, thereby having the preliminary suppression arrangement to enter into the suppressing state, during deflection of the pawl from the engagement position into the release position.

16. The motor vehicle lock according to claim 13, wherein the lock latch comprises an ejector element which moves the preliminary latch suppressing element into the release position during a closing cycle.

17. The motor vehicle lock according to claim 1, wherein the preliminary latch suppressing element is a lever pivotable around an axis or an elastically bendable wire or strip.

18. A method for operating a motor vehicle lock, wherein the motor vehicle lock comprises a lock latch and a pawl, which is assigned to the lock latch, wherein the lock latch can be brought into an open position, into a preliminary latching position and into a main latching position, wherein the lock latch, when in one of the latching positions, is or may be brought into holding engagement with a lock striker, wherein a closing cycle of the motor vehicle lock comprises moving the lock latch from the open position via the preliminary latching position to the main latching position, wherein the pawl may fall into at least one engagement position, in which it is in blocking engagement with a preliminary latching detent or a main latching detent of the lock latch for blocking the lock latch in its preliminary latching position or its main latching position, wherein the pawl may be deflected into at least one release position, in which it releases the lock latch, wherein a pawl actuation lever is provided for deflecting the pawl into the release position, wherein the deflection of the pawl from the engagement position into the release position is being blocked by a crash blocking arrangement, when the actuation movement of the pawl actuation lever surpasses a rapidity threshold, wherein the pawl is being prevented from falling towards or into the engagement position at the preliminary latching detent during a closing cycle by a preliminary latch suppressing arrangement.

19. The motor vehicle lock according to claim 3, wherein the engagement position of the pawl when in engagement with the preliminary latching detent is basically similar to the engagement position of the pawl when in engagement with the main latching detent.

20. The motor vehicle lock according to claim 8, wherein the blocking lever comprises an inertia element, which inertial characteristic causes the blocking arrangement to move into or remain in the blocking state when the actuation movement of the pawl actuation lever surpasses a rapidity threshold.
